(19) United States
(12) Patent Application Publication
(10) Pub. No.: US 2020/0410191 A1
(43) Pub. Date: Dec. 31, 2020

(54) FINGERPRINT SENSING ARRANGEMENT

(71) Applicant: Fingerprint Cards AB, GÖTEBORG (SE)

(72) Inventors: Søren SKOVGAARD CHRISTENSEN, DYSSEGAARD (DK); Hans THÖRNBLOM, KUNGSBACKA (SE); Frank RIEDIJK, DELFT (NL)

(73) Assignee: Fingerprint Cards AB, GÖTEBORG (SE)

(21) Appl. No.: 16/767,222

(22) PCT Filed: Dec. 4, 2018
(86) PCT No.: PCT/SE2018/051243

§ 371 Date: May 27, 2020

(30) Foreign Application Priority Data
Dec. 11, 2017 (SE) 1751526-3

(51) Int. Cl. G06K 9/00; G06F 3/044; G06F 3/041

(52) U.S. Cl. CPC G06K 9/0002; G06F 3/04144; G06F 3/0445

(57) ABSTRACT

The present invention relates to a fingerprint sensing arrangement and to a method for providing a fingerprint pattern signal. For providing the fingerprint pattern signal a sensing signals from the sensing circuits of at least two sensing elements are combined according to an arithmetic operation to form a combined sensing signal. The combined sensing signal is compared to a threshold value. Based on the comparison a binary value is output. The fingerprint pattern signal comprises at least one set of binary values.

### FIELD OF THE INVENTION

The present invention relates to a fingerprint sensing arrangement for sensing a fingerprint pattern of a user's finger, to an electronic device comprising such fingerprint sensing arrangement, and to a method for providing a fingerprint pattern signal representative of a fingerprint pattern of a user's finger.

### BACKGROUND OF THE INVENTION

Various types of biometric systems are used more and more in order to provide for increased security and/or enhanced user convenience. In particular, fingerprint sensing systems have been adopted in, for example, consumer electronic devices, thanks to their small form factor, high performance and user acceptance.

Fingerprint sensors are generally comprised of a pixel matrix which is configured to sense the fingerprint pattern of a finger. Signals from each of the pixel elements are collected and subsequently processed to form a fingerprint image. Ideally, the final fingerprint image is a low noise high resolution fingerprint image which can be used for fingerprint recognition applications and that can be acquired relatively fast.

However, forming a high quality fingerprint image is associated with a number of challenges. For example, the absolute signal level from each pixel element depends on several more or less uncontrollable factors such as the pressure of the finger on the pixel matrix and the level of humidity of the finger. A relatively successful way to sample an appropriate signal level is to adjust the signal offset and signal gain. A further challenge is to handle common mode noise which may affect the absolute noise level.

U.S. Pat. No. 7,965,877 discloses a fingerprint sensor which appears to provide for a reduced influence of noise and is configured to generate binary images. The binary images are formed by inputting the signal from a sensing capacitor of the fingerprint sensor and a voltage reference from a voltage source to a voltage comparator. The signal from the sensing capacitor is measured after having been charged, whereby the discharge time depends on the capacitive coupling to the finger (e.g. ridge or valley coupling). The output from the voltage comparator is high (e.g. “1”) as long as the capacitive discharge from the sensing capacitor provides a voltage larger than the voltage reference. The output from the voltage comparator is used as input in a pulse comparator where it is compared to a pulse reference. If the width of the output pulse from the voltage comparator is longer than that of the pulse reference it can be concluded that the sensed capacitance relates to a ridge capacitance.

Although the solution proposed by U.S. Pat. No. 7,965,877 seems to provide for acquiring fingerprint images with reduced influence to the absolute signal levels, there still appears to be room for improvement.

### SUMMARY

In view of above-mentioned and other drawbacks of the prior art, it is an object of the present invention to provide for sensing of a fingerprint pattern with reduced impact of the common mode noise in the sensing signals.

According to a first aspect of the present invention, there is provided a fingerprint sensing arrangement for sensing a fingerprint pattern of a user's finger for providing a fingerprint pattern signal, the fingerprint sensing arrangement comprising: an array of sensing elements for sensing the fingerprint pattern, each sensing element comprising: a sensing structure for capacitive coupling with the finger, each sensing structure being covered by a dielectric structure, and sensing circuitry for providing sensing signals indicative of the capacitive coupling between the sensing structure and the finger in response to a change in potential difference between a sensing structure potential of the sensing structure and a finger potential of the finger, wherein the fingerprint sensing arrangement is configured to provide a combined sensing signal based on a combination of at least two sensing signals according to an arithmetic operation, wherein the fingerprint sensing arrangement further comprises: a plurality of comparing circuits, wherein each comparing circuit is configured to compare a respective combined sensing signal to a threshold value, and output a binary value based on the comparison with the threshold value, wherein the fingerprint pattern signal comprises at least one set of binary values output from the plurality of comparing circuits.

The present invention is based upon the realization to compare sensing signals from individual sensing elements and output a binary value based on that comparison instead of relying directly on the absolute level of the sensing signal. The comparing of the sensing signals may be performed in an analogue domain. Accordingly, analog sensing signals are compared for providing a digital binary output.

Advantages with the invention includes that the absolute common-mode signal level of the sensing signals becomes less relevant (or even irrelevant).

The arithmetic operation may for example be to calculate a differential between the sensing signals, and in such case the differential signal may for example be centered on about zero. Determining a binary value based on the combined (analog) sensing signals, (e.g. the differential between the sensing signals), the common challenge in conventional sensing circuits to determine an appropriate signal offset before sampling is highly alleviated or even eliminated.

The sensing elements may, for example, be capacitive sensing elements, each providing a measure indicative of the capacitive coupling between that particular sensing element and a finger surface touching the sensor surface. Sensing elements at locations corresponding to ridges in the fingerprint will exhibit a stronger capacitive coupling to the finger than sensing elements at locations corresponding to valleys in the fingerprint.

Moreover, each sensing structure may advantageously be provided in the form of a metal plate, so that the equivalence of a parallel plate capacitor is formed by the sensing structure (the sensing plate), the local finger surface, and the protective dielectric top layer (and any air that may locally exist between the local finger surface and the protective layer, depending on location of ridges and valleys in the fingerprint pattern). A change of the charge carried by the sensing structure resulting from the change in potential difference between the finger and the sensing structure is an indication of the capacitance of such a parallel plate capacitor, which is in turn an indication of the distance between the sensing structure and the finger surface. Thereby, an image of the fingerprint pattern can be acquired by means of determining the capacitive coupling between each sensing structure and the finger.

The protective top dielectric structure, which also may be referred to as a coating, may advantageously be at least 20 μm thick and have a high dielectric strength to protect the underlying structures of the fingerprint sensing device from wear and tear as well as from electrostatic discharge (ESD). Even more advantageously, the protective top layer may be approximately 100 μm thick, or in the range of 500-700 μm thick, or even thicker.

The signals may be analog values indicative of a voltage, which may in turn be proportional to the capacitance of the capacitor constituted by the finger (or other conductive object in the vicinity of the finger detecting structure), the finger detecting structure and the dielectric material there between.

The sensed fingerprint pattern may be used for various purposes, such as biometric enrollment or authentication, or fingerprint pattern based navigation etc.

According to an embodiment, each sensing element in the array of sensing elements may comprise a comparing circuit. This advantageously enables a large number of combinations of sensing elements which sensing signals can be compared for outputting binary values. Furthermore, by incorporating a comparing circuit in the sensing element provides a compact solution for sensing a fingerprint pattern with reduced common mode noise.

According to embodiments, the fingerprint sensing arrangement may be configured to combine the sensing signal from one sensing element with the sensing signal from one other sensing element. Accordingly, in one advantageous possible implementation the combined sensing signal is a combination of only two sensing signals. By including the sensing signals from only two sensing elements in each combined sensing signal is advantageous from for example a signal routing perspective.

In another embodiment, the fingerprint sensing arrangement may be configured to apply gains to the sensing signals prior to combining the sensing signals to form the combined sensing signal, compare the combined sensing signal with the threshold value, and output a binary value based on the comparison with the threshold value. Applying gains to the sensing signals allows for giving the sensing signals from different sensing elements a different weight which provides for combining sensing signals from various combinations of sensing elements.

In one possible implementation the gains add up to zero. Thus, if the gain values are accumulated the accumulated value is zero.

According to possible implementations, a first gain may be applied to the sensing signals from a first set of sensing elements, and a second gain is applied to the sensing signal from at least one other sensing element not comprised in the first set of sensing elements, wherein the first gain is different from the second gain. Combining the sensing signals from the first set of sensing elements with the sensing signals from the at least one other sensing element advantageously enables to collect accumulated sensing signals in a single shot. Accordingly, the fingerprint pattern signal from a single shot measurement may in this way comprise spatial information of the fingerprint pattern in more than one direction across the array of sensing elements.

According to one embodiment, a first combined sensing signal may be compared to a first threshold value, and a second combined sensing signal may be compared to a second threshold value different from the first threshold value, wherein the comparing circuits are configured to output a first set of binary values based on the comparison with the first threshold value, and a second set of binary values based on the comparison with the second threshold value, wherein the fingerprint pattern signal comprises at least the first set of binary values and the second set of binary values.

The threshold values may be based on the position of at least one of the sensing elements from which one of the sensing signals is received, the position being the position in the array of sensing elements. Thus, the threshold may be different depending on the spatial location of the present sensing element (e.g. one of the sensing elements from which a sensing signal in the combined sensing signal originates) in the array of sensing element thereby providing a spatially varying threshold. This advantageously provides for adapting the threshold depending on the sensing signal quality which may vary across an image, for example it may be possible to reduce non-uniformity in the resulting fingerprint image which may be reconstructed from the fingerprint pattern signal.

According to one possible implementation a fingerprint sensing arrangement may be configured to: combine the sensing signals from sensing elements spatially separated from each other in a first spatial direction to produce a first combined sensing signal which is compared to a first threshold value, and output a first set of binary values based on the comparison with the first threshold value; combine the sensing signals from sensing elements spatially separated from each other in a second spatial direction to produce a second combined sensing signal which is compared to a second threshold value, and output a second set of binary values based on the comparison with the second threshold value; wherein the fingerprint pattern signal comprises at least the first set of binary values and the second set of binary values. In order to provide information in the fingerprint pattern signal that spans the two dimensions of the array of sensing elements, it is in some implementations advantageous to sample in two different directions separately and subsequently combine the sets of binary values. For example, this is advantageous in the case of combining sensing signals from two neighboring sensing elements in one direction at the time.

Accordingly, two sets of binary values may be provided, each representative of the comparison in a respective spatial direction. This also means that two differential samples are obtained per sensing element and thereby sufficient binary data is available for reconstructing a fingerprint image.

The first set of binary values may be a binary image representation in the first spatial direction, and the second set of binary values may be a binary image representation in the second spatial direction, wherein the fingerprint pattern signal may be a combined binary image representation based on the first set of binary values and the second set of binary values.

Furthermore, the first spatial direction may be orthogonal to the second spatial direction in a sensing plane of the array of sensing elements.

In addition, the first threshold may be different from the second threshold.

The threshold values may be zero. In some embodiments at least one of the threshold values is non-zero.

Using a non-zero threshold provides the advantage of compensating for imperfections in analog circuitry comprised in the fingerprint sensing arrangement. Such imperfections may cause imbalance between sensing elements. For example, applied gains to the sensing signals may not be perfectly accurate and this inaccuracy may result in an offset in the combined sensing signal. This offset may be compensated for by choosing an appropriate non-zero threshold.

Further, the threshold values may be variable which provides for tuning the threshold. For example, a fingerprint pattern signal may be provided and a fingerprint image may be reconstructed from the fingerprint pattern signal. Based on the quality of the reconstructed fingerprint image, the threshold(s) may be tuned and another fingerprint pattern signal may be determined based on further sensing signals. By collecting several sets of fingerprint pattern signals with different thresholds, a fine tuned reconstructed fingerprint image may be provided by selecting the highest quality fingerprint image.

According to embodiments, each sensing element comprises a one bit data storage unit for temporally storing the binary values associated with the respective sensing element. In this way, a fast one-shot capture from the entire array of sensing elements may be achieved.

Each comparing circuit may be configured to receive the sensing signal from at least two neighboring sensing elements. From a signal routing point of view, it may be advantageous for the comparing circuit to receive sensing signals from neighboring sensing elements.

The neighboring sensing elements may be orthogonally neighboring or diagonally neighboring, i.e. in a typical matrix of sensing elements (commonly denoted “pixel”) each sensing element (except at the edge of the matrix) is surrounded by eight neighboring sensing elements, four orthogonally neighboring and four diagonally neighboring.

The sensing circuitry may be a charge amplifier connected to at least one of the sensing structures for providing the sensing signal indicative of a change in charge carried by the at least one sensing structure, wherein each of the charge amplifiers comprises: a first input connected to the at least one sensing structure; a second input configured to receive a sensing reference potential (GND, or drive); an output providing the sensing signal; a feedback capacitor connected between the first input and the output; and at least one amplifier stage between the first and second inputs, and the output, wherein at least one of the comparing circuits is connected to the output to receive the sensing signal.

The comparing circuits may each be provided as a comparator which may take the differential between the sensing signals input to the comparator and output a binary value (i.e. 1 or 0) based on whether the differential is above zero or below zero.

The fingerprint arrangement may be comprised in an electronic device, comprising processing circuitry configured to receive the fingerprint pattern signal and reconstruct a fingerprint image based on the fingerprint pattern signal.

The fingerprint sensing arrangement may be part of a capacitive fingerprint sensor. The electronic device may be a mobile device such as a mobile phone, but may also be e.g. a desktop computer, tablet, smart card etc.

According to a second aspect of the present invention there is provided a method for providing a fingerprint pattern signal representative of a fingerprint pattern of a user's finger, the fingerprint pattern being sensed by a fingerprint sensing arrangement comprising: an array of sensing elements for sensing the fingerprint pattern, each sensing element comprising: a sensing structure for capacitive coupling with the finger, each sensing structure being covered by a dielectric structure, and sensing circuitry for providing sensing signals indicative of the capacitive coupling between the sensing structure and the finger in response to a change in potential difference between a sensing structure potential of the sensing structure and a finger potential of the finger, wherein the method comprises: determining a combined sensing signal based on at least two sensing signals according to an arithmetic operation, comparing the combined sensing signal to a threshold value;

outputting a binary value based on the comparison with the threshold value, and providing the fingerprint pattern signal comprising at least one set of binary values.

Combining sensing signals may comprise to calculate a differential between the sensing signals.

Further embodiments of, and effects obtained through this second aspect of the present invention are largely analogous to those described above for the first aspect of the invention.

In summary, the present invention relates to a fingerprint sensing arrangement and to a method for providing a fingerprint pattern signal. For providing the fingerprint pattern signal a sensing signals from the sensing circuits of at least two sensing elements are combined according to an arithmetic operation to form a combined sensing signal. The combined sensing signal is compared to a threshold value. Based on the comparison a binary value is output. The fingerprint pattern signal comprises at least one set of binary values.

Further features of, and advantages with, the present invention will become apparent when studying the appended claims and the following description. The skilled addressee realize that different features of the present invention may be combined to create embodiments other than those described in the following, without departing from the scope of the present invention.

### BRIEF DESCRIPTION OF THE DRAWINGS

These and other aspects of the present invention will now be described in more detail, with reference to the appended drawings showing an example embodiment of the invention, wherein:

FIG. 1 schematically illustrates an application for a fingerprint sensing device according to an example embodiment of the present invention;

FIG. 2 schematically shows the fingerprint sensing device in FIG. 1;

FIG. 3a-c are conceptual illustrations of embodiments of the invention;

FIG. 4 conceptually illustrates an array of sensing elements and different spatial relationships between sensing elements;

FIG. 5a-h each conceptually illustrates a spatial relationship between sensing elements having associated gains;

FIG. 6a is a schematic cross section of a portion of a fingerprint sensing arrangement according to an embodiment;

FIG. 6b is a schematic cross section of a portion of a fingerprint sensing arrangement according to an embodiment;

FIG. 7 conceptually illustrates spatially varying thresholds in an array of sensing elements;

FIG. 8 is a flow-chart schematically illustrating a method according to an embodiment of the present invention; and

FIG. 9 is a flow-chart schematically illustrating a method according to an embodiment of the present invention.

### DETAILED DESCRIPTION OF EXAMPLE EMBODIMENTS

In the present detailed description, various embodiments of the fingerprint sensing system and method according to the present invention are mainly described with reference to a mobile device in the form a mobile phone having an integrated fingerprint sensing device. However, it should be noted that many other kinds of electronic devices may have such a fingerprint sensing device integrated, such as tablets, desktop computers, laptops, smart cards, etc.

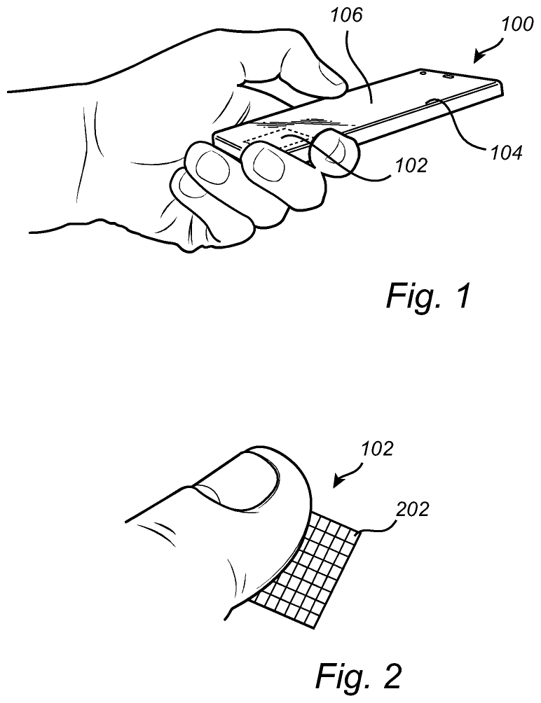

Turning now to the drawings and in particular to FIG. 1, there is schematically illustrated an example of an electronic device configured to apply the concept according to the present disclosure, in the form of a mobile device 100 with an integrated fingerprint sensor 102 and a display unit 104 with a touch screen interface 106. In this embodiment the fingerprint sensor 102 is arranged on a front side of the mobile device 100, where also the display unit 104 is positioned. The fingerprint sensor 102 may, for example, be used for unlocking the mobile device 100 and/or for authorizing transactions carried out using the mobile device 100, etc. The fingerprint sensor 102 may of course also be placed on the back side or on the side of the mobile device 100.

Preferably and as is apparent for the skilled person, the mobile device 100 shown in FIG. 1 further comprises a first antenna for WLAN/Wi-Fi communication, a second antenna for telecommunication communication, a microphone, a speaker, and a phone control unit. Further hardware elements are of course possibly comprised with the mobile device.

It should furthermore be noted that the invention may be applicable in relation to any other type of electronic devices, such as a laptop, a remote control, a tablet computer, smart card comprising a fingerprint sensor, or any other type of present or future similarly configured device, including any type of IoT (Internet of Things) devices where there is a desire to allow for user specific settings and/or identification/authentication of a user to be implemented.

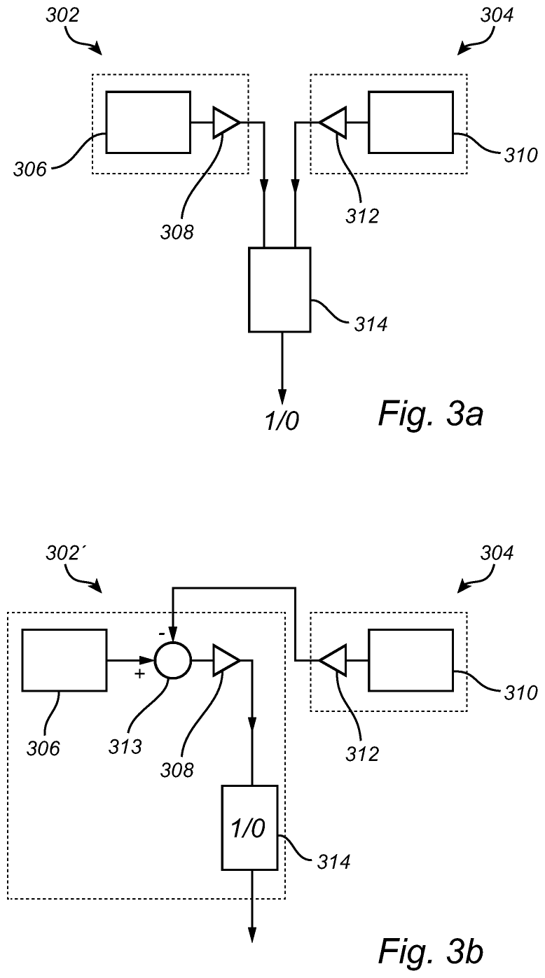

With reference to FIG. 2, there is conceptually illustrated a somewhat enlarged view of the fingerprint sensor 102. In the case of employing a capacitive sensing technology, the fingerprint sensor 102 is configured to comprise a large plurality of sensing elements, preferably arranged as a two-dimensional array. The two-dimensional array may have sizes depending on the planned implementation and in an embodiment 160×160 pixels are used. Other sizes are of course possible and within the scope of the invention, including two-dimensional array with less pixels as compared to the above example. A single sensing element (also denoted as a pixel) is in FIG. 2 indicated by reference numeral 202.

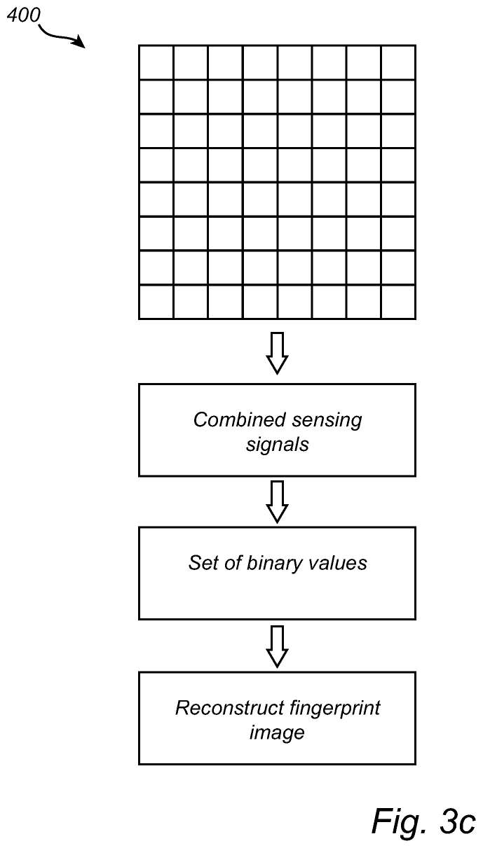

FIG. 3a conceptually illustrates two sensing elements 302 and 304 of a fingerprint sensing arrangement, each comprising a sensing structure 306, 310 and a sensing circuitry 308, 312. A comparing circuit 314 is configured to receive sensing signals from the sensing circuitries 308, 312 and to combine the sensing signals according to an arithmetic operation. For example, the comparing circuit 314 may calculate the differential between the sensing signals from the sensing circuits 308, 312 for forming the combined sensing signal. The combined sensing signal is subsequently compared to a threshold value by the comparing circuit 314. If the combined sensing signal is larger than (or below) the threshold value, a binary value “1” may be output. However, if the combined sensing signal is below (or larger than) the threshold, a binary value “0” may be output. At least one set of binary values are used for reconstructing a fingerprint image. Note that the described scheme in FIG. 3a according to the inventive concept does not require a full analog-to-digital converter.

FIG. 3b conceptually illustrates two sensing elements 302′ and 304, each comprising a sensing structure 306, 310 and a sensing circuitry 308, 312. In FIG. 3b, the sensing signals are combined by a combination circuit 313. The combination circuit 313 receives the sensing signal from the sensing element 304 and uses that sensing signal as input to the sensing circuitry 308 in the other sensing element 302′. The output sensing signal form the sensing circuit 308 is input to a comparing circuit 314 which compares it to a threshold value. In FIG. 3b, the comparing circuit 314 is integrated with the sensing element 302′. However, the comparing circuit 314 may also be arranged outside the sensing element 302′. The combination circuit 313 may be configured to add the sensing signals to each other or to subtract one sensing signal from another sensing signal.

FIG. 3c conceptually illustrates an overview work-flow in accordance with the inventive concept. From the sensing elements of the array 400 of sensing elements (e.g. “pixels”) combined sensing signals are determined, one for each of the sensing elements. For some combinations of sensing elements, there may be sensing elements which do not have a sensing element to be combined with, such as the outer rim of sensing elements in case of combining with the nearest neighbor. In such case, the sensing elements that lack a combining sensing element may be ignored.

Based on comparing the combined sensing signals to threshold value(s), binary values are determined and form a set of binary values. The set of binary values is thus a binary representation of the fingerprint pattern sensed by the sensing elements. The fingerprint pattern signal comprises the set of binary values.

The determining of the set of binary values including the combining of sensing signals may be performed in hardware and does advantageously not require a full analog-to-digital converter. A fingerprint image that can be used for biometric authentication may be reconstructed from the set of binary values.

The threshold value may for example be zero, but in some possible implementations the threshold is non-zero. A non-zero threshold value may be advantageously implemented in order to take into account for imperfections in analog circuitry in the fingerprint sensing arrangement which may cause offsets in the sensing signals.

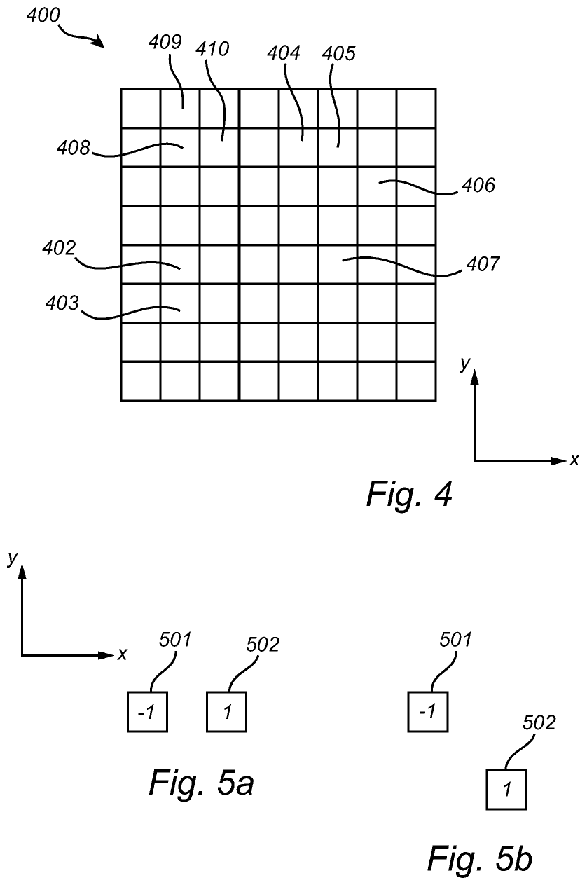

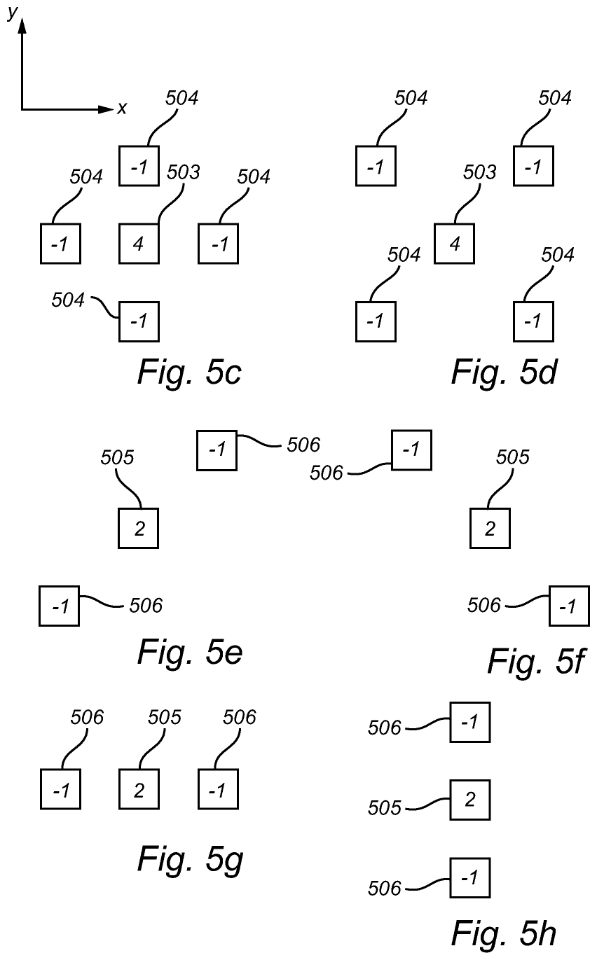

The sensing elements from which the sensing signals are received and combined to form the combined sensing circuit may be selected according to various patterns, some of which now will be described with reference to FIG. 4 and FIGS. 5a-h.

FIG. 4 conceptually illustrates an array 400 of sensing elements of which only a portion are provided with reference numerals (402-407). The sensing signals that are used for providing a combined sensing signal may be acquired from neighboring sensing elements such as sensing element 402 and sensing element 403, which are nearest neighbors in the array 400. Sensing elements 402 and 403 are neighboring along a first spatial direction (y). Another possibility is that sensing elements are neighboring along a second spatial direction (x), such as sensing elements 404 and 405, which are also nearest neighbors. In this particular example embodiment the first spatial direction (y) is orthogonal to the second spatial direction (x).

When forming a fingerprint pattern signal comprising at least one set of binary values, the sensing elements may each provide a one bit binary value depending on the outcome of the comparison of a combined sensing signal with a threshold. Once the configuration of the combination of sensing signals is selected, each sensing element provides one binary value. For example, if the configuration of sensing elements is selected to be neighboring along the first spatial direction (y) (such as 402 and 403), then the sensing signal from each sensing element is combined with the sensing signal form its nearest neighbor in the first spatial direction (y). The combined sensing signals are each compared to a threshold and each comparison provides a binary value output. The combination of sensing signals is switchable, in other words, the sensing elements from which sensing signals are combined may be varied between sensing operations.

For reconstructing a fingerprint image from the set of binary values spatial information covering the both the x and y direction is preferably included. This means that the fingerprint pattern signal may comprise a set of binary values that include both the x and y direction based on having combined sensing signals from sensing elements that are spatially separated from each other in more than one direction, for example by combining sensing signals from three or more sensing elements (see example in FIGS. 5c-e).

Alternatively, a first set of binary values is determined from combination of sensing signals from sensing elements spatially separated in the x direction (such as represented by 404 and 405) and a second set of binary values is determined from combination of sensing signals from sensing elements spatially separated in the y direction (such as represented by 402 and 403). The first set of binary values and the second set of binary values are combined and serve as a basis for reconstructing a fingerprint image. In this case, the binary values from comparisons in the x direction and comparisons in the y direction are determined for all sensing elements in the array 400.

In some embodiments, more than one binary value is output from each sensing element in the array 400. For example, a first set of binary values are determined based on comparing combined sensing signals from each sensing elements (e.g. sensing element 408) with a respective sensing element (e.g. sensing element 409) in the first spatial direction (y) to a threshold value. A second set of binary values are determined based on comparing combined sensing signals from each sensing element (e.g. sensing element 408) and a respective sensing element (e.g. sensing element 410) in the second spatial direction (x) to the threshold value. Effectively, this provides a 90 degree spatial pattern with two binary values provided from each sensing element. The fingerprint sensing signal is in this case comprised of the first set of binary values and the second set of binary values.

Further, the sensing elements from which the sensing signals are provided and that are used to form the combined sensing signal may not necessarily be neighboring sensing elements. For example, the sensing elements 406 and 407 spatially separated in both the x and y directions represent a possible pattern configuration of the sensing elements from which the combined sensing signal may be formed.

FIG. 5a-h schematically illustrates various configurations of sensing element patterns which may be used for forming combined sensing signals.

According to some possible embodiments in accordance with the inventive concept, a gain may be applied to the sensing signals prior to combining the sensing signals to form the combined sensing signal. In FIGS. 5a-h, the number conceptually shown in each sensing element (represented by a box) indicates the gain applied to the sensing signal from that sensing element.

FIG. 5a and FIG. 5b illustrate two sensing elements 501 and 502 from which a comparing circuit may be configured to receive sensing signals. The sensing elements 501 and 502 may or may not be nearest neighbors. A gain −1 is applied to the sensing signal from the sensing element 501 and a gain 1 is applied to the sensing signal from the sensing element 502 before forming the combined sensing signal according to an arithmetic operation (e.g. addition). In FIG. 5a the sensing elements 501 and 502 are located along the spatial direction x with respect to each other whereas in FIG. 5b the sensing elements 501 and 502 are diagonally located with respect to each other in the array 400 (see FIG. 4).

FIGS. 5c and 5d illustrate a center sensing element 503 and four sensing elements 504 arranged around the center sensing element 503 in two different spatial patterns. A first gain, in this case a gain −1 is applied to the sensing signal from the sensing elements 504 and a second gain of 4 is applied to the sensing signal from the sensing element 503. The combined sensing signal is thus formed from the sensing signals from five sensing elements in the illustrated example shown in FIGS. 5c and 5d. In FIG. 5c the sensing elements 504 are located along the direction (x) and (y) and in FIG. 5d the sensing elements are located along directions diagonal in the array 400 (see FIG. 4), in other words at an angle with respect to the directions (x) and (y). The sensing elements 503 and 504 may be nearest neighbors. In other possible embodiments, two or more of the sensing elements 503 and 504 may not be nearest neighbors.

FIGS. 5e-h illustrate further possible spatial relationships between the sensing elements from which sensing signals are combined. In the illustrated example configurations a first gain of −1 is applied to the sensing signals from two sensing elements 506, and a second gain of 2 is applied to another sensing element 505. The sensing elements 506 are either diagonally located from sensing element 505 (FIG. 5e-f) in the array, or orthogonally located from sensing element 505 (FIGS. 5g-h) in the array. The sensing elements 505 and 506 may be nearest neighbors. In other possible embodiments, two or more of the sensing elements 505 and 506 may not be nearest neighbors.

FIGS. 5a-h shows exemplary spatial relationships between the sensing elements from which sensing signals are combined. These examples should not be construed as limiting the scope, in practice any arbitrary pattern can be used as long as the gain values add up to zero. For example, any gradient based or Laplacian based filter kernel maybe used.

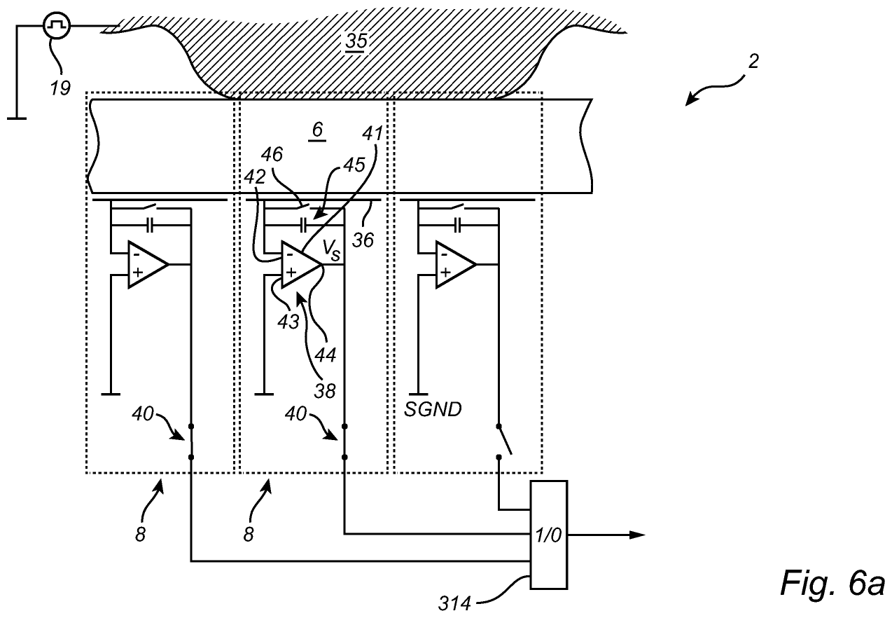

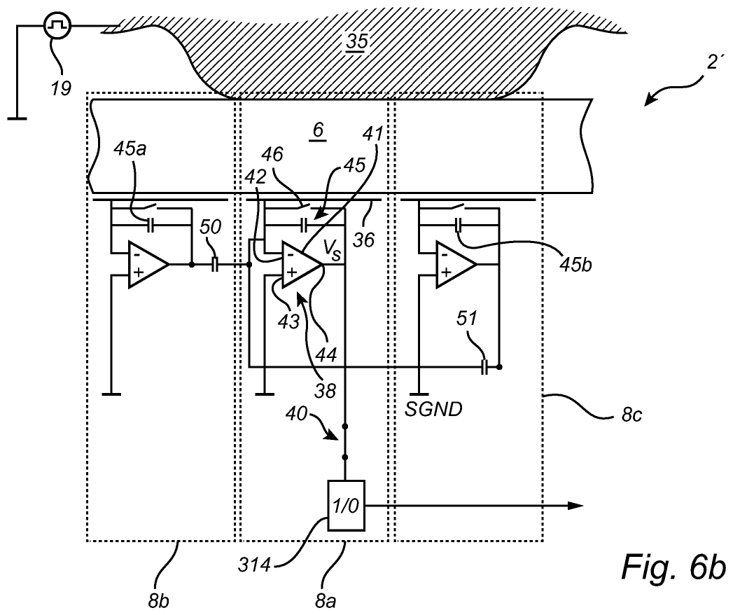

FIG. 6a is a schematic cross section of a portion of a fingerprint sensing arrangement 2 with a finger 35 placed on top of a protective dielectric top layer 6 covering the sensor array (see e.g. FIG. 2 or 4). Referring to FIG. 6a, the exemplary fingerprint sensing device 2 comprises an excitation signal providing circuit 19 electrically connected to the finger via a conductive finger drive structure (not shown in FIG. 4), and a plurality of sensing elements 8.

As is schematically indicated in FIG. 6a, each sensing element 8 comprises a conductive sensing structure, here in the form of a metal plate 36 underneath the protective dielectric top layer 6, a charge amplifier 38, and selection circuitry, here functionally illustrated as a simple selection switch 40 for allowing selection/activation of the sensing element 8.

The charge amplifier 38 comprises at least one amplifier stage, here schematically illustrated as an operational amplifier (op amp) 41 having a first input (negative input) 42 connected to the sensing structure 36, a second input (positive input) 43 connected to sensor ground or another reference potential, and an output 44. In addition, the charge amplifier 38 comprises a feedback capacitor 45 connected between the first input 42 and the output 44, and reset circuitry, here functionally illustrated as a switch 46, for allowing controllable discharge of the feedback capacitor 45. The charge amplifier 38 may be reset by operating the reset circuitry 46 to discharge the feedback capacitor 45.

As is often the case for an op amp 41 in a negative feedback configuration, the voltage at the first input 42 follows the voltage at the second input 43. Depending on the particular amplifier configuration, the potential at the first input 42 may be substantially the same as the potential at the second input 43, or there may be a substantially fixed offset between the potential at the first input 42 and the potential at the second input 43. In the configuration of FIG. 6a, the first input 42 of the charge amplifier is virtually grounded.

When a time-varying potential is provided to the finger 35 by the excitation signal providing circuitry 19, a corresponding time-varying potential difference occurs between the sensing structure 36 and the finger 35.

The above-described change in potential difference between the finger 35 and the sensing structure 36 results in a sensing voltage signal V, on the output 44 of the charge amplifier 38.

When the indicated sensing elements 8 are selected for sensing, the respective selection switch 40 is closed to provide the sensing signals to a comparing circuit 314. The comparing circuit 314 combines the sensing signals from the selected sensing elements 8 and compares the combined sensing signal to a threshold value. Based on the comparison the comparing circuit 314 outputs a binary value to form a binary representation of the fingerprint pattern of the finger 35 on the sensor 2.

In FIG. 6a, the finger 35 is shown as being connected to an excitation circuit 19 for providing the desired potential difference between the finger 35, and the sensing plates 36 of the sensor array. It should be noted that this desired potential difference may alternatively be provided by changing the ground level of the fingerprint sensing device in relation to the ground level of the electronic device (such as mobile phone 1) in which the fingerprint sensing device 2 is included. Furthermore, the potential difference may also be provided by changing the potential of the sensing structures 36 themselves.

The comparing circuit 314 may be provided in the form of a voltage comparator configure to compare received voltages (sensing signals) with a threshold value, and output a binary value based on the comparison.

FIG. 6b is a schematic cross section of a portion of another fingerprint sensing arrangement 2′. FIG. 6b resembles FIG. 6a to a large extent, and only the main differences will be explained here. As illustrated in FIG. 6b, the sensing signal from a first sensing element 8a is combined, here in the way of a subtraction, with the sensing signals from the sensing elements 8b and 8c by using the sensing signals from the sensing elements 8b and 8c as input to the sensing circuitry of the sensing element 8a. Thus, the sensing signals from the sensing elements 8b and 8c are input to the first input 42 of the operational amplifier in this present example for providing a differential between the sensing signal from the sensing elements 8b-c and the sensing signal from the sensing element 8a. The output of a sensing element 8b is capacitively coupled to the input of the amplifier 38 of another sensing element 8a via coupling capacitor 50. Further the output of a further sensing element 8c is capacitively coupled to the input of the amplifier 38 of the sensing element 8a via coupling capacitor 51. The output signal from the sensing element 8a is the combined sensing signal, here provided as a differential signal, and is provided to the comparing circuitry 314. The comparing circuitry is here integrated in the sensing element 8a.

By selecting the capacitance of the coupling capacitor 50, 51 with respect to the capacitance of the feedback capacitor 45a, 45b of the corresponding sensing element 8b, 8c, the corresponding gain of the respective sensing signal may be applied. For example, the gain of the sensing signal from the sensing element 8b is determined from the ratio between the capacitance of the feedback capacitor 45a and the coupling capacitor 50.

In the example embodiment illustrated in FIG. 6b, the sensing elements 8b and 8c are neighboring sensing elements with the sensing element 8a.

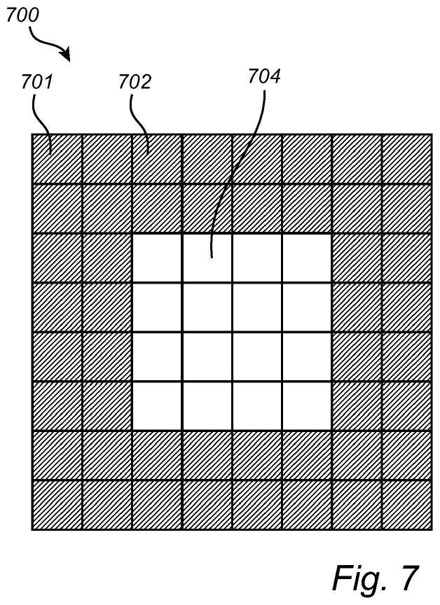

FIG. 7 conceptually illustrates an array 700 of sensing elements. A single sensing element is in FIG. 7 indicated by reference numeral 701. In the array 700 of sensing elements there is a group 702 of sensing elements arranged in outer positions in the array, adjacent to the outer perimeter of the array 700. There is another group 704 of sensing elements arranged to the center of the array 700. The threshold values with which the combined sensing signals are compared may be different depending on the position of at least one of the sensing element from which a sensing signal is received. For example, the sensing signals from at least two sensing elements in the group 702 may be combined to form a combined sensing signal. This combined sensing signal may be compared with a first threshold value. Further, the sensing signals from at least two sensing elements in the group 704 may be combined to form another combined sensing signal. That combined sensing signal may be compared with a second threshold value different from the first threshold value.

Accordingly, the threshold may be different depending on the spatial location of the present sensing element in the array of sensing element thereby providing a spatially varying threshold. In this way it may be possible to reduce non-uniformity in the resulting fingerprint image reconstructed from the fingerprint pattern signal. For example, due to non-uniform pressure applied by a user's finger on the sensor surface which comprises the array 700 of sensing signals, the capacitive coupling between the finger and the sensing structures may vary across the array 700. This variation may cause non-uniformity in the resulting fingerprint image. Using a spatially varying threshold that depends on the position of the sensing element in the array may compensate for the non-uniform coupling to the array 700, varying electronics offset in amplifiers in the array, varying sensing distance from sensing structure to the surface of the sensor, or other effects that may cause non-uniformity across the array 700 of sensing elements 701.

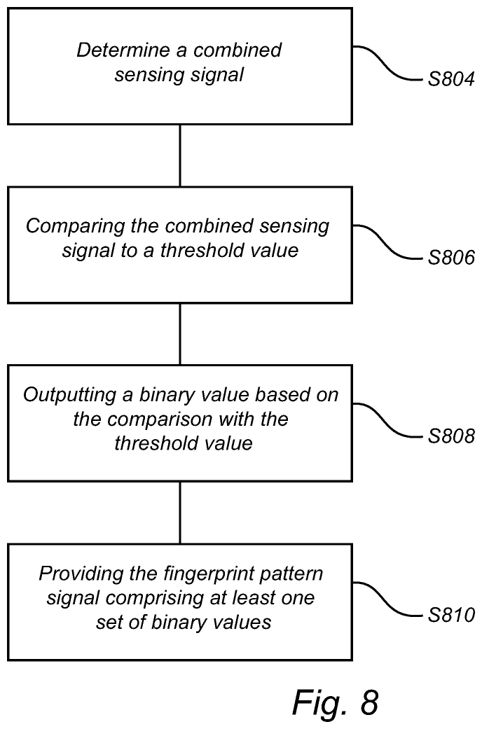

FIG. 8 shows a flow-chart of method steps according to embodiments of the invention. In step S804 a combined sensing signal is determined based on at least two sensing signals according to an arithmetic operation. The arithmetic operation may for example be to calculate a differential or to sum the sensing signals. The combined sensing signal is compared to a threshold value in step S806. Based on the comparison with the threshold value, a binary value is output in step S808. In step S810 is a fingerprint pattern signal provided comprising at least one set of binary values.

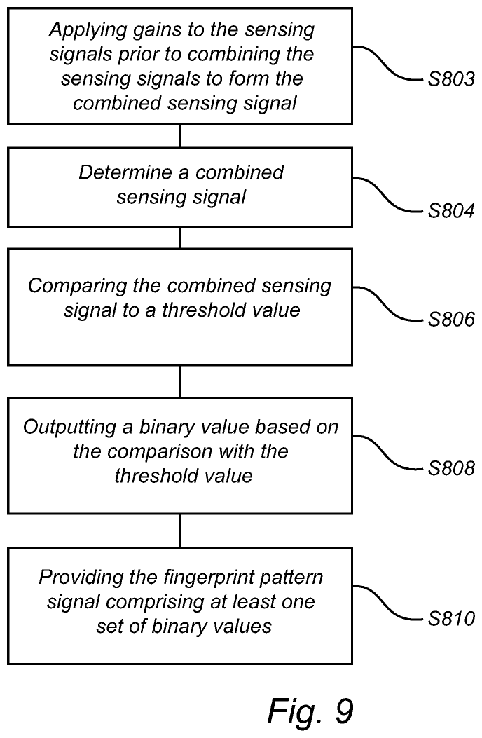

FIG. 9 shows a flow-chart of method steps according to further embodiments of the invention. In addition to the steps already described with reference to FIG. 8, an additional step S803 is here provided which includes applying gains to the sensing signals prior to combining the sensing signals to form the combined sensing signal, i.e. prior to step S804.

A control unit may include a microprocessor, microcontroller, programmable digital signal processor or another programmable device. The control unit may also, or instead, include an application specific integrated circuit, a programmable gate array or programmable array logic, a programmable logic device, or a digital signal processor. Where the control unit includes a programmable device such as the microprocessor, microcontroller or programmable digital signal processor mentioned above, the processor may further include computer executable code that controls operation of the programmable device. It should be understood that all or some parts of the functionality provided by means of the control unit (or generally discussed as “processing circuitry”) may be at least partly integrated with the fingerprint sensing arrangement.

Although the figures may show a sequence the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps. Additionally, even though the invention has been described with reference to specific exemplifying embodiments thereof, many different alterations, modifications and the like will become apparent for those skilled in the art.

In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A fingerprint sensing arrangement for sensing a fingerprint pattern of a user's finger for providing a fingerprint pattern signal, the fingerprint sensing arrangement comprising:
an array of sensing elements for sensing the fingerprint pattern, each sensing element comprising:
a sensing structure for capacitive coupling with the finger, each sensing structure being covered by a dielectric structure, and
sensing circuitry for providing sensing signals indicative of the capacitive coupling between the sensing structure and the finger in response to a change in potential difference between a sensing structure potential of the sensing structure and a finger potential of the finger,
wherein the fingerprint sensing arrangement is configured to provide a combined sensing signal based on a combination of at least two sensing signals according to an arithmetic operation,
wherein the fingerprint sensing arrangement further comprises:
a plurality of comparing circuits, wherein each comparing circuit is configured to compare a combined sensing signal to a threshold value, and output a binary value based on the comparison with the threshold value,
wherein the fingerprint pattern signal comprises at least one set of binary values output from the plurality of comparing circuits.

2. The fingerprint sensing arrangement according to claim 1, wherein each sensing element in the array of sensing elements comprises a comparing circuit.

3. The fingerprint sensing arrangement according to claim 1, wherein fingerprint sensing arrangement is configured to combine the sensing signal from one sensing element with the sensing signal from one other sensing element.

4. The fingerprint sensing arrangement according to claim 1, wherein the fingerprint sensing arrangement is configured to:
apply gains to the sensing signals prior to combining the sensing signals to form the combined sensing signal,
compare the combined sensing signal with the threshold value, and
output a binary value based on the comparison with the threshold value.

5. The fingerprint sensing arrangement according to claim 4, wherein the gains add up to zero.

6. The fingerprint sensing arrangement according to claim 4,
wherein a first gain is applied to the sensing signals from a first set of sensing elements, and
a second gain is applied to the sensing signal from at least one other sensing element not comprised in the first set of sensing elements, wherein the first gain is different from the second gain.

7. The fingerprint sensing arrangement according to claim 1,
wherein a first combined sensing signal is compared to a first threshold value, and
a second combined sensing signal is compared to a second threshold value different from the first threshold value,
wherein the comparing circuits are configured to output a first set of binary values based on the comparison with the first threshold value, and a second set of binary values based on the comparison with the second threshold value,
wherein the fingerprint pattern signal comprises at least the first set of binary values and the second set of binary values.

8. The fingerprint sensing arrangement according to claim 1, wherein the threshold values are based on the position of at least one of the sensing elements from which one of the sensing signals is received, the position being the position in the array of sensing elements.

9. The fingerprint sensing arrangement according to claim 1, wherein the fingerprint sensing arrangement is configured to:
combine the sensing signals from sensing elements spatially separated from each other in a first spatial direction to produce a first combined sensing signal which is compared to a first threshold value, and output a first set of binary values based on the comparison with the first threshold value;
combine the sensing signals from sensing elements spatially separated from each other in a second spatial direction to produce a second combined sensing signal which is compared to a second threshold value, and output a second set of binary values based on the comparison with the second threshold value;
wherein the fingerprint pattern signal comprises at least the first set of binary values and the second set of binary values.

10. The fingerprint sensing arrangement according to claim 9, wherein the first spatial direction is orthogonal to the second spatial direction in a sensing plane of the array of sensing elements.

11. The fingerprint sensing arrangement according to claim 9, wherein the first threshold is different from the second threshold.

12. The fingerprint sensing arrangement according to claim 9, wherein the first set of binary values is a binary image representation in the first spatial direction, and the second set of binary values is a binary image representation in the second spatial direction,
wherein the fingerprint pattern signal is a combined binary image representation based on the first set of binary values and the second set of binary values.

13. The fingerprint sensing arrangement according to claim 1, wherein each sensing element comprises a one bit data storage unit for temporally storing the binary values associated with the respective sensing element.

14. The fingerprint sensing arrangement according to claim 1, wherein the sensing circuitry is a charge amplifier connected to at least one of the sensing structures for providing the sensing signal indicative of a change in charge carried by the at least one sensing structure, wherein each of the charge amplifiers comprises:
a first input connected to the at least one sensing structure;
a second input configured to receive a sensing reference potential;
an output providing the sensing signal;
a feedback capacitor connected between the first input and the output; and
at least one amplifier stage between the first and second inputs, and the output,
wherein at least one of the comparing circuits is connected to the output to receive the sensing signal.

15. The fingerprint sensing arrangement according to claim 1, wherein each comparing circuit is configured to receive the sensing signal from at least two neighboring sensing elements.

16. The fingerprint sensing arrangement according to claim 1, wherein each of the comparing circuits is configured to perform a differential operation for combining sensing signals.

17. The fingerprint sensing arrangement according to claim 1, wherein the threshold values are zero.

18. The fingerprint sensing arrangement according to claim 1, wherein at least one of the threshold values is non-zero.

19. The fingerprint sensing arrangement according to claim 1, wherein the threshold values are variable.

20. A method for providing a fingerprint pattern signal representative of a fingerprint pattern of a user's finger, the fingerprint pattern being sensed by a fingerprint sensing arrangement comprising:
an array of sensing elements for sensing the fingerprint pattern, each sensing element comprising:
a sensing structure for capacitive coupling with the finger, each sensing structure being covered by a dielectric structure, and
sensing circuitry for providing sensing signals indicative of the capacitive coupling between the sensing structure and the finger in response to a change in potential difference between a sensing structure potential of the sensing structure and a finger potential of the finger,
wherein the method comprises:
determining a combined sensing signal based on at least two sensing signals according to an arithmetic operation,
comparing the combined sensing signal to a threshold value;
outputting a binary value based on the comparison with the threshold value, and
providing the fingerprint pattern signal comprising at least one set of binary values.

21.-26. (canceled)
